(19) United States
(12) Patent Application Publication
(10) Pub. No.: US 2020/0009968 A1
(43) Pub. Date: Jan. 9, 2020

(54) VEHICLE AND VEHICLE COOLING SYSTEM

(71) Applicant: FORD GLOBAL TECHNOLOGIES, LLC, Dearborn, MI (US)

(72) Inventors: Hamish LEWIS, Troy, MI (US); Christian Brent SCHOENEMAN, Southgate, MI (US); Ravi GOPAL, Novi, MI (US)

(21) Appl. No.: 16/030,293

(22) Filed: Jul. 9, 2018

(51) Int. Cl. B60L 11/18; H01M 10/613; H01M 10/625; H01M 10/6568; H01M 10/635; H01M 10/6569

(52) U.S. Cl. CPC B60L 11/1874; H01M 10/613; H01M 10/625; H01M 2220/20; H01M 10/635; H01M 10/6569; B60L 2240/36; H01M 10/6568

(57) ABSTRACT

A vehicle includes a battery, a first cooling loop, a second cooling loop, and a controller. The first and second cooling loops are configured to circulate coolant to cool the battery. The controller is programmed to, responsive to ambient air temperature being less than a threshold, circulate coolant through the first cooling loop alone. The controller is further programmed to, responsive to ambient air temperature exceeding the threshold, circulate coolant through the second cooling loop and isolate the first cooling loop from the battery.

### TECHNICAL FIELD

The present disclosure relates to electric and hybrid vehicles, and thermal management systems for electric and hybrid vehicles.

### BACKGROUND

Electric and hybrid vehicles may include one or more thermal management systems that regulate the temperatures of various components.

### SUMMARY

A vehicle includes a battery, a first cooling loop, a second cooling loop, and a controller. The first and second cooling loops are configured to circulate coolant to cool the battery. The controller is programmed to, responsive to ambient air temperature being less than a threshold, circulate coolant through the first cooling loop alone. The controller is further programmed to, responsive to ambient air temperature exceeding the threshold, circulate coolant through the second cooling loop and isolate the first cooling loop from the battery.

A vehicle includes a battery, a first cooling loop, a second cooling loop, and a controller. The first and second cooling loops are configured to circulate coolant to transfer battery generated heat to ambient surroundings and a refrigerant loop, respectively. The controller is programmed to, responsive to ambient air temperature being less than a threshold, circulate coolant through the first cooling loop alone. The controller is further programmed to, responsive to ambient air temperature exceeding the threshold, circulate coolant through the second cooling loop and isolate the first cooling loop from the battery.

A vehicle includes a battery, a first cooling loop, a second cooling loop, and a controller. The first and second cooling loops are respectively configured to the circulate coolant from the battery to a radiator and a chiller. The controller is programmed to, responsive to ambient air temperature being less than a threshold, circulate coolant through the first cooling loop alone. The controller is further programmed to, responsive to ambient air temperature exceeding the threshold, circulate coolant through the second cooling loop and isolate the battery from the first cooling loop.

### BRIEF DESCRIPTION OF THE DRAWINGS

FIG. 1 is a schematic illustration of a representative powertrain of an electric vehicle; and

FIG. 2 is schematic illustration of a representative vehicle cooling system that is configured to cool various components of the electric vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

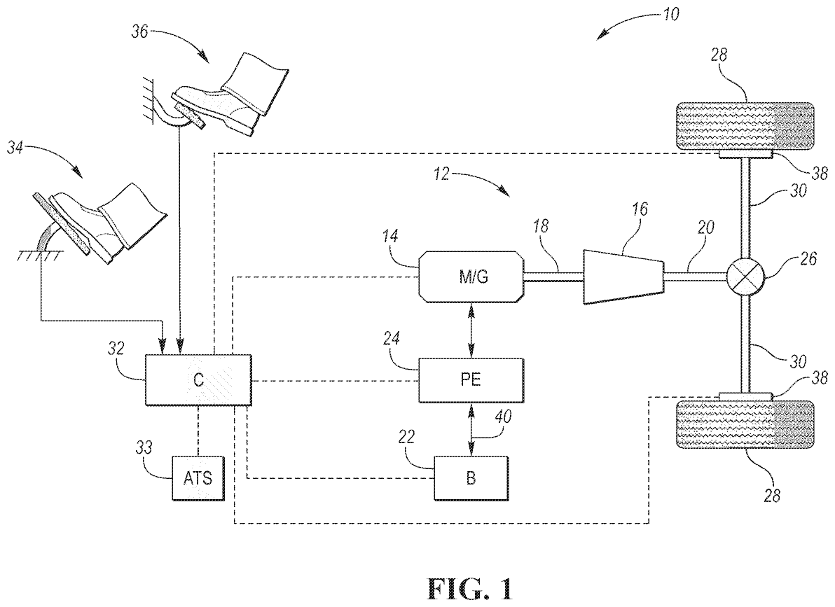

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the traction battery 22 transmits stored electrical energy through wiring 40 to the power electronics 24 that may include an inverter, for example. The power electronics 24 convert DC voltage from the battery 22 into AC voltage to be used by the M/G 14. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the schematic illustrated in FIG. 1 is merely representative and is not intended to be limiting. Other configurations are contemplated without deviating from the scope of the disclosure. It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component concentration or presence, intake air flow (MAF), etc.

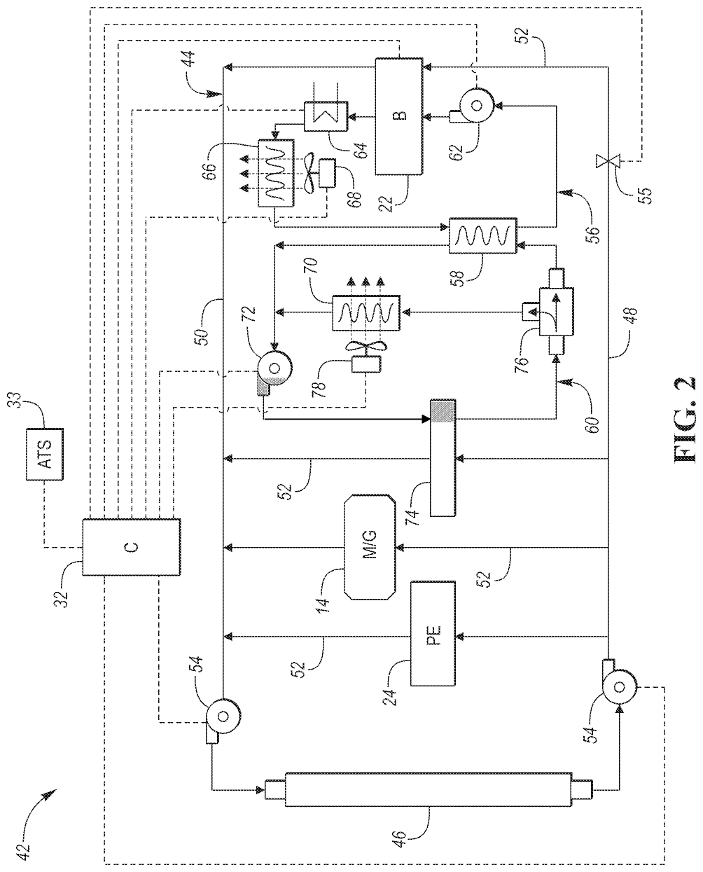

Referring to FIG. 2, a representative vehicle cooling system 42 that is configured to cool various components of the electric vehicle 10 is illustrated. The vehicle cooling system 42 includes a first cooling loop 44. The first cooling loop 44 is configured to circulate coolant between various components of the electric vehicle 10 and a heat exchanger 46 (or radiator) in order to cool the various components. More specifically, the various components may include the M/G 14, power electronics 24, and battery 22. Heat generated by the M/G 14, power electronics 24, and battery 22 is transferred to the coolant within the first cooling loop 44 and is then rejected to the ambient air via the heat exchanger 46.

The first cooling loop 44 may include a supply line 48 that supplies coolant from the heat exchanger 46 to the M/G 14, power electronics 24, and battery 22. The coolant is then flowed from the supply line 48 across (or through conduits adjacent to) the M/G 14, power electronics 24, and battery 22 in order to cool the M/G 14, power electronics 24, and battery 22. The coolant is then flowed from the M/G 14, power electronics 24, and battery 22 to a return line 50 of first cooling loop 44 and then back to the heat exchanger 46 where the heat transferred from the M/G 14, power electronics 24, and battery 22 to the coolant is then rejected to the ambient air. The M/G 14, power electronics 24, and battery 22 may each be positioned on separate parallel coolant lines 52 that extend from the supply line 48 to the return line 50. The first cooling loop 44 may include one or more pumps 54 that are configured to direct coolant from the heat exchanger 46 to the M/G 14, power electronics 24, and battery 22, and from the M/G 14, power electronics 24, and battery 22 back to the heat exchanger 46. The pumps may be powered by an electrical power source (e.g., battery 22) and may be in electronic communication with the controller 32. A valve 55 may be disposed within the first cooling loop 44. The valve 55 may be configured to allow coolant to flow across (or through conduits adjacent to) the battery 22 when in an opened position. The valve 55 may be configured to isolate the first cooling loop 44 from the battery 22 when in a closed position. The valve 55 may be powered by an electrical power source (e.g., battery 22) and may be in electronic communication with the controller 32.

The electric vehicle 10 includes a second cooling loop 56. The second cooling loop 56 is configured to circulate coolant between the battery 22 and a chiller 58 in order to cool the battery 22. Heat generated by the battery 22 is transferred to the coolant within the second cooling loop 56 and is then rejected to a refrigerant loop 60 via the chiller 58. The coolant within the second cooling loop 56 is supplied to the battery 22 from the chiller 58. The coolant is then flowed across (or through conduits adjacent to) the battery 22 in order to cool the battery 22. The coolant is then flowed from the battery 22 back to the chiller where the heat transferred from the battery 22 to the coolant is then rejected to the refrigerant loop 60. The second cooling loop 56 may include one or more pumps 62 that are configured to direct coolant from the chiller 58 to the battery 22, and from the battery 22 back to the chiller 58. The pumps 62 may be powered by an electrical power source (e.g., battery 22) and may be in electronic communication with the controller 32.

The second cooling loop 56 may include a heater 64, such as a positive temperature coefficient (PTC) heater, that is configured to heat the coolant within the second cooling loop 56. The heater 64 may be powered by an electrical power source (e.g., battery 22) and may be in electronic communication with the controller 32. The second cooling loop 56 may also include a heater core 66. A fan 68 may be configured to direct air across the heater core 66 in order to heat a cabin of the electric vehicle 10. The fan 66 may be powered by an electrical power source (e.g., battery 22) and may be in electronic communication with the controller 32. The output of the fan 66, heater 64, and pump 62 may be adjusted by the controller 32 based on a user input (i.e., the user interacting with a human machine interface) requesting cabin heating.

The refrigerant loop 60 includes the chiller 58, an evaporator 70, a compressor 72, a condenser 74, and a thermal expansion valve 76. The thermal expansion valve 76 may be a two-way valve that directs refrigerant across the chiller 58 and the evaporator 70 in parallel between the condenser 74 and the compressor 72. Heat generated within the second cooling loop 56 by the battery 22 or other components is transferred to the refrigerant within the refrigerant loop 60 via the chiller 58. Heat may also be transferred from the vehicle cabin to the refrigerant within the refrigerant loop 60 via the evaporator 70. The refrigerant is then directed to the compressor 72 and then on to the condenser 74. The heat transferred to the refrigerant form the second cooling loop 56 via the chiller 58 and form the vehicle cabin via the evaporator 70 is then transferred to the coolant within the first cooling loop 44 via the condenser 74, where it is ultimately rejected to the ambient air via the heat exchanger 46. The refrigerant then returns to the thermal expansion valve 76. Since the condenser 74 is configured to transfer heat from the refrigerant to a liquid coolant (as opposed to the ambient air), the condenser 74 may be referred to as a liquid-cooled condenser or a water-cooled condenser. The condenser 70 may also be positioned on separate parallel coolant line 52 that extends from the supply line 48 to the return line 50 of the first cooling loop 44.

A fan 78 may be configured to direct air across the evaporator 70 in order to cool the vehicle cabin of the electric vehicle 10. The fan 78 may be powered by an electrical power source (e.g., battery 22) and may be in electronic communication with the controller 32. The output of the fan 78 and compressor 72 may be adjusted by the controller 32 based on a user input (i.e., the user interacting with a human machine interface) requesting cabin cooling.

The controller 32 may be programmed to circulate coolant through the first cooling loop 44 alone to cool the battery 22 in response to the ambient air temperature being less than a threshold value. More specifically, the controller 32 may operate the one or more pumps 54 of the first cooling loop 44, shutdown the one or more pumps 62 of the second cooling loop 56, and command the valve to transition to or maintain an open position such that coolant within the first cooling loop 44, but not within the second cooling loop 56, flows across (or through conduits adjacent to) the battery 22 in order to cool the battery 22.

The controller 32 may further be programmed to circulate coolant through the second cooling loop 56 and isolate the first cooling loop 44 from the battery 22 in response to ambient air temperature exceeding the threshold value. More specifically, the controller 32 may operate the one or more pumps 62 of the second cooling loop 56 and command the valve to transition to or maintain a closed position such that coolant within the second cooling loop 56, but not within the first cooling loop 44, flows across (or through conduits adjacent to) the battery 22 in order to cool the battery 22. The controller 32 may also be programmed to circulate refrigerant through the refrigerant loop 60 in response the ambient air temperature exceeding the threshold value.

The vehicle cooling system 42 in the present disclosure allows the electric vehicle 10 to conserve energy when the ambient air temperature is low (i.e., below the threshold value) by shutting down the refrigeration system (i.e., the refrigerant loop 60) and cooling the battery 22 via the first cooling loop, which may already be operating to cool the M/G 14 and the power electronics 24. Specifically, shutting down the refrigeration system conserves energy by shutting down the compressor 72, which is powered by the electrical power source (e.g., battery 22).

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a battery;
first and second cooling loops configured to circulate coolant to cool the battery; and
a controller programmed to,
responsive to ambient air temperature being less than a threshold, circulate coolant through the first cooling loop alone, and
responsive to ambient air temperature exceeding the threshold, circulate coolant through the second cooling loop and isolate the first cooling loop from the battery.

2. The vehicle of claim 1, wherein the first cooling loop further comprises a heat exchanger that is configured to transfer heat generated by the battery to ambient surroundings.

3. The vehicle of claim 1 further comprising a refrigerant loop, and wherein the second cooling loop further comprises a chiller that is configured to transfer heat generated by the battery to the refrigerant loop.

4. The vehicle of claim 3, wherein the controller is further programmed to, responsive to ambient air temperature exceeding the threshold, circulate refrigerant through the refrigerant loop.

5. The vehicle of claim 4, wherein the refrigerant loop includes an evaporator that is in parallel with the chiller and is configured to cool a vehicle cabin.

6. The vehicle of claim 3 further comprising a condenser that is configured to transfer heat from the refrigerant loop to the first cooling loop.

7. The vehicle of claim 1 further comprising an electric machine that is powered by the battery and is configured to propel the vehicle, and wherein the first cooling loop is configured to cool the electric machine in parallel with the battery.

8. The vehicle of claim 7 further comprising power electronics that are configured to deliver electrical power form the battery to the electric machine, and wherein the first cooling loop is configured to cool the power electronics in parallel with the electric machine and the battery.

9. The vehicle of claim 1 further comprising a valve that is configured to isolate the first cooling loop from the battery when in a closed position, and wherein the controller is further programmed to, responsive to ambient air temperature exceeding the threshold, transition the valve to the closed position.

10. A vehicle comprising:
a battery;
first and second cooling loops configured to circulate coolant to transfer battery generated heat to ambient surroundings and a refrigerant loop, respectively; and
a controller programmed to,
responsive to ambient air temperature being less than a threshold, circulate coolant through the first cooling loop alone, and
responsive to ambient air temperature exceeding the threshold, circulate coolant through the second cooling loop and isolate the first cooling loop from the battery.

11. The vehicle of claim 10 further comprising a chiller that is configured to transfer heat from the second cooling loop to the refrigerant loop.

12. The vehicle of claim 11, wherein the controller is further programmed to, responsive to ambient air temperature exceeding the threshold, circulate refrigerant through the refrigerant loop.

13. The vehicle of claim 11 further comprising a condenser that is configured to transfer heat from the refrigerant loop to the first cooling loop.

14. The vehicle of claim 10 further comprising a valve that is configured to isolate the first cooling loop from the battery when in a closed position, and wherein the controller is further programmed to, responsive to ambient air temperature exceeding the threshold, transition the valve to the closed position.

15. A vehicle comprising:
a battery;
first and second cooling loops, respectively configured to circulate coolant from the battery to a radiator and a chiller; and
a controller programmed to,
responsive to ambient air temperature being less than a threshold, circulate coolant through the first cooling loop alone, and
responsive to ambient air temperature exceeding the threshold, circulate coolant through the second cooling loop and isolate the battery from the first cooling loop.

16. The vehicle of claim 15 further comprising a refrigerant loop, and wherein the chiller is configured to transfer heat from the second cooling loop to the refrigerant loop.

17. The vehicle of claim 16, wherein the controller is further programmed to, responsive to ambient air temperature exceeding the threshold, circulate refrigerant through the refrigerant loop.

18. The vehicle of claim 16, wherein the refrigerant loop includes an evaporator that is in parallel with the chiller and is configured to cool a vehicle cabin.

19. The vehicle of claim 16 further comprising a condenser that is configured to transfer heat from the refrigerant loop to the first cooling loop.

20. The vehicle of claim 15 further comprising a valve that is configured to isolate the first cooling loop from the battery when in a closed position, and wherein the controller is further programmed to, responsive to ambient air temperature exceeding the threshold, transition the valve to the closed position.
